(19) United States
(12) Patent Application Publication
(10) Pub. No.: US 2026/0098950 A1
(43) Pub. Date: Apr. 9, 2026

(54) ACTIVE VIBRATION CANCELLATION SYSTEM USING PIEZOELECTRIC ELEMENTS FOR TOWED ACOUSTIC ARRAY

(71) Applicant: Raytheon Company, Arlington, VA (US)

(72) Inventor: Caitlin C. Bogdan, Little Compton, RI (US)

(21) Appl. No.: 19/353,132

(22) Filed: Oct. 8, 2025

Related U.S. Application Data
(60) Provisional application No. 63/705,365, filed on Oct. 9, 2024.

(51) Int. Cl. G01S 7/52; G01H 11/08; G01S 7/521; G01S 15/00

(52) U.S. Cl. CPC G01S 7/52077; G01H 11/08; G01S 7/521; G01S 15/003

(57) ABSTRACT

A towed acoustic array configured for measurement of acoustic signals underwater includes an array cable having a plurality of acoustic sensing modules distributed along a length of the array cable and an active vibration cancellation system. The active vibration cancellation system may include two or more piezoelectric elements within the array cable including a measurement piezoelectric element and a vibration cancellation piezoelectric element. Each piezoelectric element may include piezoelectric material provided around a jacket of an inner base cable. A vibration controller within the array cable may receive vibration data from the measurement piezoelectric element and inject vibration cancellation signals into the vibration cancellation piezoelectric element to reduce and/or cancel vibrations along the array cable. The piezoelectric material of the piezoelectric elements may include a seamless monolithic structure controllable by a single control signal.

### CLAIM OF PRIORITY

This patent application claims the benefit of priority to U.S. Provisional Application Serial No. 63/705,365, filed October 9, 2024, which is incorporated by reference herein in its entirety.

### TECHNICAL FIELD

Embodiments pertain to towed arrays and measurement of acoustic signals underwater.

### BACKGROUND

A towed acoustic array is a sonar system of hydrophones that is towed behind a submarine or a surface ship on a cable. Trailing the hydrophones behind the vessel, on a cable that can be kilometers long, keeps the array's sensors away from the ship's own noise sources, greatly improving its signal-to-noise ratio, and hence the effectiveness of detecting and tracking faint contacts, such as quiet, low noise-emitting submarine threats, or seismic signals. A towed array offers superior resolution and range compared with hull-mounted sonar. It also covers the baffles, the blind spot of hull-mounted sonar. However, effective use of the system limits a vessel's speed and care must be taken to protect the cable from damage. Hydrophones in a towed array system are placed at specific distances along the cable, the end elements far enough apart to gain a basic ability to triangulate on a sound source. Similarly, various elements may be angled to triangulate an estimated vertical depth of a target. One issue that can significantly impact the performance of towed acoustic arrays is vibrations.

One example of vibrations are flow-induced vibrations. As the array is towed through water, vortex shedding occurs along its length. This creates periodic forces that cause the cable to vibrate, a phenomenon known as strumming. These vibrations can introduce noise into the hydrophone measurements, reducing the array's sensitivity to distant acoustic sources.

Another example of vibrations are ship-induced vibrations. Vibrations from the towing vessel's engines, propellers, and other machinery can propagate down the cable. These mechanical disturbances can be picked up by the hydrophones, interfering with the detection of target signals.

Another example of vibrations is caused by wave-induced motion. Surface waves can cause vertical motion of the towing ship, which is transmitted to the array. This up-and-down motion can create additional noise and affect the array's shape, impacting its beamforming capabilities.

Another example of vibrations results from cable shape distortion. Vibrations can cause the cable to deviate from its ideal straight-line configuration. This affects the assumed geometry used in beamforming algorithms, potentially leading to errors in source localization.

Another issue with vibrations is acoustic masking. Vibration-induced noise can mask weak acoustic signals of interest. This reduces the effective detection range of the array and its ability to discriminate between different sound sources.

Another issue with vibrations is structural fatigue. Persistent vibrations can lead to material fatigue in the cable and its components. Over time, this may result in decreased performance or even failure of array elements.

Another issue with vibrations is non-uniform tension. Vibrations can cause variations in tension along the length of the array. This affects the acoustic properties of the array and can introduce additional noise and distortions.

Another issue with vibrations is coherent noise. Some vibration modes can produce coherent noise across multiple hydrophones. This type of noise is particularly challenging to filter out using traditional signal processing techniques.

Thus, there are needs for mitigating these vibrations to improve the performance and reliability of towed acoustic arrays in underwater sensing applications.

### BRIEF DESCRIPTION OF THE DRAWINGS

FIG. 1 illustrates vibrations experienced by a towed acoustic array, in accordance with some embodiments.

FIG. 2 illustrates a towed acoustic array that includes an active vibration cancellation system, in accordance with some embodiments.

FIG. 3 is a functional block diagram of an active vibration cancellation process, in accordance with some embodiments.

FIG. 4 illustrates a cross section of an array cable with a piezoelectric element, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Embodiments disclosed herein are directed toward a towed acoustic array with an active vibration cancellation system configured to reduce and/or cancel vibrations. Some embodiments are directed a towed acoustic array configured for measurement of acoustic signals underwater. In these embodiments, the towed acoustic array may comprise an array cable having a plurality of acoustic sensing modules distributed along a length of the array cable and an active vibration cancellation system. In some embodiments, the active vibration cancellation system may comprise two or more piezoelectric elements within the array cable. The two or more piezoelectric elements may include a measurement piezoelectric element and a vibration cancellation piezoelectric element. Each piezoelectric element may comprise piezoelectric material provided around a jacket of an inner base cable. The active vibration cancellation system may also include a vibration controller within the array cable. The vibration controller may be configured to receive vibration data from the measurement piezoelectric element and inject vibration cancellation signals into the vibration cancellation piezoelectric element to reduce and/or cancel vibrations along the array cable. In some embodiments, the piezoelectric material of the piezoelectric elements may comprise a seamless monolithic structure controllable by a single control signal. These embodiments, as well as others are described in more detail below.

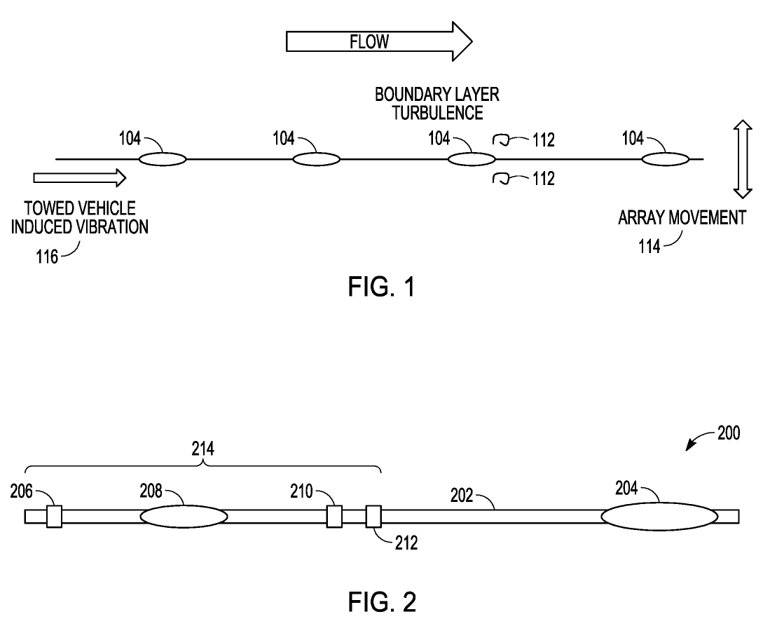

FIG. 1 illustrates vibrations experienced by a towed acoustic array, in accordance with some embodiments. Towed arrays are used to measure acoustic signals under water and in the ocean. As mentioned above, these arrays are subject to multiple sources over mechanical vibration that can raise the noise floor, degrading the overall performance of the array. Several sources of vibration are passed along the length of the array and can accumulate. For example, the vibrations experienced by a towed acoustic array may include tow vehicle induced vibration 116, boundary layer turbulence vibration 112 caused by the acoustic sensing modules 104 being pulled through the water, and/or array movement vibration 114 caused by movement of the array (e.g., fishtailing) as the array is being pulled through the water. These vibrations may be in the kHz range, although that is not a requirement.

Embodiments disclosed herein may reduce mechanically induced vibration by introducing active vibration cancellation systems into the cable jacket using piezoelectric materials. In some embodiments, these elements may be 3D printed onto or into the jacket of the cable which may achieve better bonding to cable jacket and improve manufacturability for active control elements. These embodiments are described in more detail below.

FIG. 2 illustrates a towed acoustic array that includes an active vibration cancellation system, in accordance with some embodiments. Towed acoustic array 200 may be configured for measurement of acoustic signals underwater. In these embodiments, the towed acoustic array 200 may comprise an array cable 202 having a plurality of acoustic sensing modules 204 distributed along a length of the array cable 202 and an active vibration cancellation system 214. In some embodiments, the active vibration cancellation system 214 may comprise two or more piezoelectric elements within the array cable 202. The two or more piezoelectric elements may include a measurement piezoelectric element 206 and a vibration cancellation piezoelectric element 210. Each piezoelectric element may comprise piezoelectric material provided around a jacket of an inner base cable. The active vibration cancellation system 214 may also include a vibration controller 208 within the array cable 202. The vibration controller 208 may be configured to receive vibration data from the measurement piezoelectric element 206 and inject vibration cancellation signals into the vibration cancellation piezoelectric element 210 to reduce and/or cancel vibrations along the array cable 202. In some embodiments, the piezoelectric material of the piezoelectric elements may comprise a seamless monolithic structure controllable by a single control signal (e.g., a voltage). These embodiments, as well as others are described in more detail below.

In these embodiments, the active vibration cancellation system 214 may be configured to reduce and/or cancel vibrations from multiple sources. For example, the vibrations may include tow vehicle induced vibration 116 (see FIG. 1), boundary layer turbulence vibration 112 caused by the acoustic sensing modules 204 being pulled through the water, and/or array movement vibration 114 caused by movement of the array (e.g., fishtailing) as the array is being pulled through the water. These vibrations may be in the kHz range, although that is not a requirement.

In some embodiments, the vibration cancellation piezoelectric element 210 may be configured to induce vibrations into the array cable to offset vibrations moving down the array cable 202. In these embodiments, the vibration cancellation signals injected into the vibration cancellation piezoelectric element 210 may actively cancel vibrations moving down the array cable 202. In some embodiments, the vibration controller 208 comprises processing circuitry and memory configured to perform active vibration damping of vibration sources being transferred through the array cable including the cable jacket.

In some embodiments, the two or more piezoelectric elements within the array cable 202 further include a feedback measurement piezoelectric element 212 configured to provide a feedback signal to the vibration controller 208 for closed-loop vibration control performed by the vibration controller 208. In some embodiments, the feedback measurement piezoelectric element 212 may be optional.

In some embodiments, the active vibration cancellation system 214 may be provided along the length of the array cable 202 prior to (i.e., upstream of an associated one of the acoustic sensing modules 204, In these embodiments, the vibration controller 208 may be provided between the measurement piezoelectric element 206 and the vibration cancellation piezoelectric element 210. The measurement piezoelectric element 206 may be provided upstream of the vibration cancellation piezoelectric element 210 (i.e., furthest from the associated acoustic sensing module 204) and the vibration cancellation piezoelectric element 210 may be provided downstream from the vibration cancellation piezoelectric element 210 (i.e., closer to the associated acoustic sensing module 204 than the measurement piezoelectric element 206). In these embodiments, the feedback measurement piezoelectric element 212 may be provided between the vibration cancellation piezoelectric element 210 and the associated acoustic sensing module 204. An example of this is illustrated in FIG. 2. In these embodiments, the active vibration cancellation system 214 may reduce and/or cancel at least the vibrations caused by boundary layer turbulence vibration 112 (FIG. 1) at the associated acoustic sensing module 204.

In some embodiments, the processing circuity of the vibration controller 208 may implement a transfer function to reduce vibrations based on the configuration of elements (e.g., known locations of the elements along the array cable 202), the response of the vibration cancellation piezoelectric element 210 and signals provided by the feedback measurement piezoelectric element 212 and the measurement piezoelectric element 206.

In some embodiments, the towed acoustic array 200 may comprise an active vibration cancellation system 214 for each of the acoustic sensing modules 204. In some of these embodiments, each active vibration cancellation system 214 may operate independently. In some of these embodiments, the active vibration cancellation system 214 may operate together sharing data (e.g., over a bus) although the scope of the embodiments is not limited in this respect.

Piezoelectric materials can convert mechanical stress into electrical signals and vice versa. This property makes them potentially useful for both sensing acoustic waves and actively dampening vibrations. In some embodiments, the piezoelectric elements within the array cable 202 may use Lead zirconate titanate (PZT). PZT is a piezoelectric ceramic material with the chemical symbols Pb (ZrTi). Piezoelectric materials generate a charge when they are compressed, twisted, or distorted, and this effect is reversible. When an electrical oscillation is applied to a PZT crystal, it vibrates mechanically, producing ultrasound. The use of 3D printed PZT allows for a seamless, monolithic PZT mass, as well as for better potential bonding to the cable jacket, which is the transfer layer for managing the vibrations. It also has the potential to increase automation of integration (e.g., the cable can be pulled through a machine and periodically stopped for processing).

In some embodiments, the acoustic sensing modules 204 may house acoustic and non-acoustic sensors and related electronics, may provide mechanical strength for towing, and may hold the fill fluid, which makes the whole module neutrally buoyant in seawater. In some embodiments, the acoustic sensors may include hydrophones. In some embodiments, the towed acoustic array 200 may perform signal processing techniques (e.g., for beamforming and Fourier analysis) which can be used not only to calculate the distance and the direction of a sound source, but also to identify the type of ship by the distinctive, acoustic signature of its machinery noises.

The boundary layer turbulence vibration 112 (FIG. 1) may be caused by a turbulent boundary layer (TBL) around a towed array and may be source of flow noise that can affect the performance of the array and the quality of data it collects. The TBL is created by fluid flow past the array's outer skin and is characterized by high Reynolds numbers. The turbulence can be dipole or quadrupole, depending on whether it arises from viscous drag at the surface or fluctuating Reynolds' stresses.

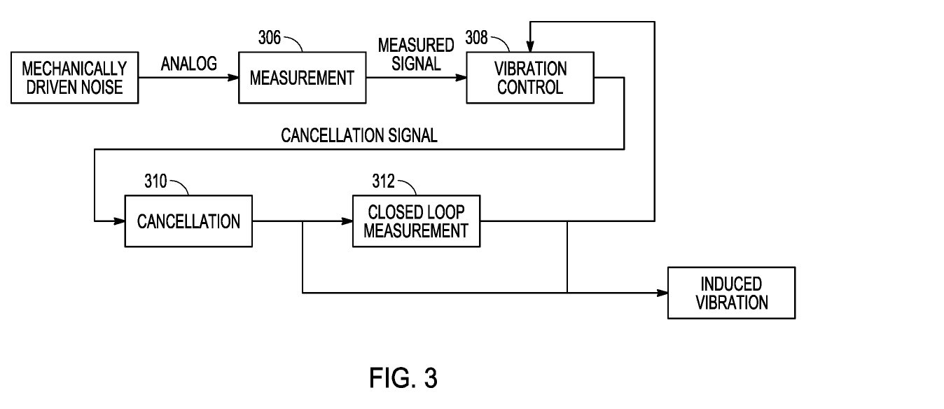

FIG. 3 is a functional block diagram of an active vibration cancellation process, in accordance with some embodiments. These embodiments are directed to a method for reducing cancelling, and/or attenuating vibrations in a towed acoustic array. In these embodiments, the towed acoustic array may be configured for measurement of acoustic signals underwater and may comprise an array cable having a plurality of acoustic sensing modules distributed along a length of the array cable. In these embodiments, the method may be performed by processing circuitry of an active vibration cancellation system. In these embodiments, the processing circuitry may be configured for measurement of vibration data (e.g., mechanically driven noise) at a vibration control element 308 from a measurement element 306 and injecting vibration cancellation signals (by cancellation element 310) to reduce vibrations along the array cable. In these embodiments, a measurement piezoelectric element and a vibration cancellation piezoelectric element may be used for measurement by measurement element 306 and cancellation by cancellation element 310, respectively. The piezoelectric elements may comprise piezoelectric material provided around a jacket of an inner base cable. In some embodiments, a feedback measurement piezoelectric element may be configured to provide a feedback signal to the vibration controller for closed-loop vibration control 312.

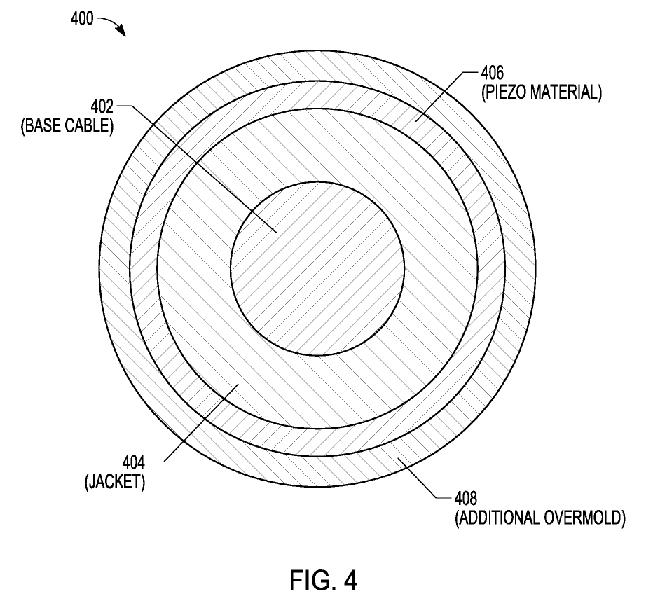

FIG. 4 illustrates a cross section of an array cable with a piezoelectric element, in accordance with some embodiments. Array cable 400 may include base cable 402, jacket 404, piezoelectric material 406 and additional overmold 408. In some embodiments, the active vibration cancellation system 214 (FIG. 2) may comprise two or more piezoelectric elements within the array cable 202. The two or more piezoelectric elements may include a measurement piezoelectric element 206 and a vibration cancellation piezoelectric element 210. Each piezoelectric element may comprise piezoelectric material 406 provided around a jacket 404 of an inner base cable 402.

In some embodiments, the piezoelectric material of the piezoelectric elements may be three-dimensionally (3D) printed onto the jacket 404 of the inner base cable 402 to form the seamless monolithic structure. In these embodiments, the piezoelectric material of the piezoelectric elements may comprise any three-dimensionally printable piezoelectric material.

In some embodiments, the piezoelectric material comprises lead zirconate titanate (PZT) although the scope of the embodiments is not limited in this respect as other piezoelectric materials that can be 3D printed onto the jacket 404 to form a seamless monolithic structure may also be suitable. Non-monolithic structures, on the other hand, may not be suitable as they could not be controlled as a single structure with a single voltage. For example, two separate piezoelectric pieces in a clamshell configuration around the jacket 404 of the inner base cable 402 would not be suitable.

In some embodiments, the towed acoustic array 200 may also include an additional overmold 408 provided around each of the piezoelectric elements and the vibration controller 208. The towed acoustic array 200 may also include a first pair of signal wires coupling the vibration controller 208 with the measurement piezoelectric element 206, a second pair of signal wires coupling the vibration controller 208 with the vibration cancellation piezoelectric element 210, and a third pair of signal wires coupling the vibration controller 208 with the feedback measurement piezoelectric element 212. In these embodiments, the pairs of signal wires may be provided beneath the additional overmold 408. In these embodiments, the additional overmold 408 may be provided from the measurement piezoelectric element 206 to the feedback measurement piezoelectric element 212 to cover the pairs of signal wires. These signal wires may run outside the jacket 404 of the inner base cable 402.

In some embodiments, the vibration controller 208 may comprise a circuitry card assembly (CCA), although the scope of the embodiments is not limited in this respect. In some embodiments, the vibration controller 208 may be a small single-board computer (SBC), such as a micro-controller board, which includes one or more processors, memory and I/O ports.

In accordance with some embodiments, the acoustic sensing modules 204 may be configured to sense acoustic signals underwater and report acoustic sensor signals via a bus within the inner base cable 402 to a central processing node, although the scope of the embodiments is not limited in this respect.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A towed acoustic array configured for measurement of acoustic signals underwater, the towed acoustic array comprising:
an array cable having a plurality of acoustic sensing modules distributed along a length of the array cable;
an active vibration cancellation system comprising:
two or more piezoelectric elements within the array cable, the two or more piezoelectric elements including a measurement piezoelectric element and a vibration cancellation piezoelectric element, each piezoelectric element comprising piezoelectric material provided around a jacket of an inner base cable of the array cable; and
a vibration controller within the array cable, the vibration controller configured to receive vibration data from the measurement piezoelectric element and inject vibration cancellation signals into the vibration cancellation piezoelectric element to reduce vibrations along the array cable,
wherein the piezoelectric material of the piezoelectric elements comprises a seamless monolithic structure controllable by a single control signal.

2. The towed acoustic array of claim 1, wherein the vibration cancellation piezoelectric element is configured to induce vibrations into the array cable to offset vibrations moving down the array cable.

3. The towed acoustic array of claim 2, wherein the vibration controller comprises processing circuitry and memory configured to perform active vibration damping of vibration sources being transferred through the array cable.

4. The towed acoustic array of claim 3, wherein the two or more piezoelectric elements within the array cable further include a feedback measurement piezoelectric element configured to provide a feedback signal to the vibration controller for closed-loop vibration control.

5. The towed acoustic array of claim 4, the active vibration cancellation system is provided along the length of the array cable prior to an associated one of the acoustic sensing modules, wherein:
the vibration controller is provided between the measurement piezoelectric element and the vibration cancellation piezoelectric element;
the measurement piezoelectric element is provided upstream of the vibration cancellation piezoelectric element;
the vibration cancellation piezoelectric element is provided downstream from the vibration cancellation piezoelectric element; and
the feedback measurement piezoelectric element is provided between the vibration cancellation piezoelectric element and the associated acoustic sensing module.

6. The towed acoustic array of claim 4, wherein the towed acoustic array comprises an active vibration cancellation system for each of the acoustic sensing modules.

7. The towed acoustic array of claim 4, wherein the piezoelectric material of the piezoelectric elements is three-dimensionally (3D) printed onto the jacket of the inner base cable to form the seamless monolithic structure.

8. The towed acoustic array of claim 7, wherein the piezoelectric material comprises lead zirconate titanate (PZT).

9. The towed acoustic array of claim 8, further comprising an additional overmold provided around each of the piezoelectric elements and the vibration controller.

10. The towed acoustic array of claim 9, further comprising:
a first pair of signal wires coupling the vibration controller with the measurement piezoelectric element;
a second pair of signal wires coupling the vibration controller with the vibration cancellation piezoelectric element; and
a third pair of signal wires coupling the vibration controller with the feedback measurement piezoelectric element,
wherein the pairs of signal wires are provided beneath the additional overmold.

11. An active vibration cancellation system for a towed acoustic array, the active vibration cancellation system comprising:
two or more piezoelectric elements within an array cable of the towed acoustic array, the two or more piezoelectric elements including a measurement piezoelectric element and a vibration cancellation piezoelectric element, each piezoelectric element comprising piezoelectric material provided around a jacket of an inner base cable of the array cable; and
a vibration controller within the array cable, the vibration controller configured to receive vibration data from the measurement piezoelectric element and inject vibration cancellation signals into the vibration cancellation piezoelectric element to reduce vibrations along the array cable,
wherein the piezoelectric material of the piezoelectric elements comprises a seamless monolithic structure controllable by a single control signal.

12. The active vibration cancellation system of claim 11, wherein the towed acoustic array is configured for measurement of acoustic signals underwater and comprises a plurality of acoustic sensing modules distributed along a length of the array cable, and
wherein the vibration cancellation piezoelectric element is configured to induce vibrations into the array cable to offset vibrations moving down the array cable.

13. The active vibration cancellation system of claim 12, wherein the vibration controller comprises processing circuitry and memory configured to perform active vibration damping of vibration sources being transferred through the array cable.

14. The active vibration cancellation system of claim 13, wherein the two or more piezoelectric elements within the array cable further include a feedback measurement piezoelectric element configured to provide a feedback signal to the vibration controller for closed-loop vibration control.

15. The active vibration cancellation system of claim 14, the active vibration cancellation system is provided along the length of the array cable prior to an associated one of the acoustic sensing modules, wherein:
the vibration controller is provided between the measurement piezoelectric element and the vibration cancellation piezoelectric element;
the measurement piezoelectric element is provided upstream of the vibration cancellation piezoelectric element;
the vibration cancellation piezoelectric element is provided downstream from the vibration cancellation piezoelectric element; and
the feedback measurement piezoelectric element is provided between the vibration cancellation piezoelectric element and the associated acoustic sensing module.

16. The active vibration cancellation system of claim 14, wherein the piezoelectric material of the piezoelectric elements is three-dimensionally (3D) printed onto the jacket of the inner base cable to form the seamless monolithic structure.

17. The active vibration cancellation system of claim 16, wherein the piezoelectric material comprises lead zirconate titanate (PZT).

18. The active vibration cancellation system of claim 17, further comprising:
an additional overmold provided around each of the piezoelectric elements and the vibration controller;
a first pair of signal wires coupling the vibration controller with the measurement piezoelectric element;
a second pair of signal wires coupling the vibration controller with the vibration cancellation piezoelectric element; and
a third pair of signal wires coupling the vibration controller with the feedback measurement piezoelectric element,
wherein the pairs of signal wires are provided beneath the additional overmold.

19. A method for reducing vibrations in a towed acoustic array, the towed acoustic array configured for measurement of acoustic signals underwater and comprising an array cable having a plurality of acoustic sensing modules distributed along a length of the array cable, the method performed by processing circuitry of an active vibration cancellation system, the method comprising:
receiving vibration data at a vibration controller from a measurement piezoelectric element; and
injecting vibration cancellation signals by the vibration controller into a vibration cancellation piezoelectric element to reduce vibrations along the array cable,
wherein each piezoelectric element comprises piezoelectric material provided around a jacket of an inner base cable and comprises a seamless monolithic structure controllable by a single control signal.

20. The method of claim 19, wherein the piezoelectric material of the piezoelectric elements comprises lead zirconate titanate (PZT) that is three-dimensionally (3D) printed onto the jacket of the inner base cable to form the seamless monolithic structure.
